(19) United States
(12) Patent Application Publication
(10) Pub. No.: US 2011/0202835 A1
(43) Pub. Date: Aug. 18, 2011

(54) ITEM SELECTION METHOD FOR TOUCH SCREEN DEVICES

(75) Inventors: Anna Kristina Jakobsson, Lund (SE); Anna Wickholm, Malmo (SE)

(73) Assignee: SONY ERICSSON MOBILE COMMUNICATIONS AB, Lund (SE)

(21) Appl. No.: 12/726,573

(22) Filed: Mar. 18, 2010

Related U.S. Application Data
(60) Provisional application No. 61/304,410, filed on Feb. 13, 2010.

(51) Int. Cl. G06F 3/048

(52) U.S. Cl. 715/702; 715/856; 715/764

(57) ABSTRACT

A user device may display content items in a content area on a touch screen display of the user device. The user device detects a touching of the touch screen display and determines a location of the touching. The user device divides the content area into a first content sub-area and a second content sub-area at a location proximate to the location of the touching, wherein a portion of the content corresponding to the touching is included in the first content sub-area. The user device shifts the first content sub-area away from the location of the touching to create a blank space between the first content sub-area and the second content sub-area.

### CROSS-REFERENCE TO RELATED APPLICATIONS

This application claims priority under 35. U.S.C. §119, based on U.S. Provisional Patent Application No. 61/304,410 filed Feb. 13, 2010, the disclosure of which is hereby incorporated by reference herein.

### TECHNICAL FIELD OF THE INVENTION

The invention relates generally to mobile devices and, more particularly, to selecting items or elements via a touch screen display on a mobile device.

### DESCRIPTION OF RELATED ART

Computer, communication and entertainment devices, such as personal computers (PCs), lap top computers, mobile terminals, personal digital assistants (PDAs), music playing devices, etc., often include a touch screen display that allow a user to interact with the device via the touch screen. In many situations, a user may wish to “select” or position a cursor within a content area on the touch screen. Unfortunately, conventional mechanisms for allowing such selection or positioning typically render the content difficult to view or ascertain, leading to user frustration.

### SUMMARY

According to one aspect, a method may include displaying content items in a content area on a touch screen display; detecting a touching of the touch screen display; determining a location of the touching; dividing the content area into a first content sub-area and a second content sub-area at a location proximate to the location of the touching such that a portion of the content items are in the first content area and a portion of the content items are in the second content sub-are, wherein a portion of the content items corresponding to the touching is included in the first content sub-area; and shifting the first content sub-area away from the location of the touching to create a space between the first content sub-area and the second content sub-area.

Additionally, the content items may include textual elements or graphical elements.

Additionally, the first content sub-area may be shifted upward on the touch screen display relative to the location of the touching.

Additionally, detecting the touching may include determining whether the touching is a content item selection or cursor placement touching.

Additionally, the method may include determining a duration of the touching; determining a movement of the touching; and determining that the touching is a content item selection or cursor placement touching based on at least of the duration of the touching or the movement of the touching.

Additionally, it may be determined that the touching is a content item selection or cursor placement touching when the duration of the touching is at least one second and the touching is stationary.

Additionally, the method may further include determining that the touching is moving vertically with respect to the content items; and shifting the first content sub-area and the second content sub-area such that the space between the first content sub-area and the second content sub-area remains proximate to the location of the touching.

Additionally, the vertical movement may cause selection of the content items between a starting location of the touching and an ending location of the touching.

Additionally, the vertical movement may cause movement of a cursor or selected content item from the portion corresponding to a starting location of the touching to the portion corresponding to an ending location of the touching.

Additionally, the method may include indicating the portion of the content items corresponding to the touching in the first content sub-area.

Additionally, the method may include determining a contact size associated with the touching; and dividing the first content sub-area from the second content sub-area by an amount based on the contact size.

In accordance with another aspect, a mobile terminal may include a touch screen display for displaying content in a content area of the touch screen display; and a processor to: detect a touching of the touch screen display; determine a location of the touching; divide the content area into a first content sub-area and a second content sub-area at a location proximate to the location of the touching, with a portion of the content being in the first content sub-area and a portion of the content being in the second content sub-area, wherein a portion of the content corresponding to the touching is included in the first content sub-area; shift the first content sub-area away from the location of the touching to create a space between the first content sub-area and the second content sub-area; and indicate the portion of the content corresponding to the touching in the first content sub-area.

Additionally, the space between the first content sub-area and the second content sub-area may be proximate to the portion of the content corresponding to the touching.

Additionally, the content may include textual elements or graphical elements.

Additionally, the first content sub-area may be shifted upward relative to the location of the touching.

Additionally, the processor may be further configured to: determine a duration of the touching; determine a movement of the touching; and determine that the touching is a content item selection or cursor placement touching based on at least of the duration of the touching or the movement of the touching.

Additionally, the processor may be further configured to highlight the portion of the content corresponding to the touching in the first content sub-area.

Additionally, the processor may be further configured to determine a contact size associated with the touching; and divide the first content sub-area from the second content sub-area by an amount based on the contact size.

In accordance with yet another aspect, a computer-readable medium having stored thereon a plurality of sequences of instructions which, when executed by at least one processor, cause the at least one processor to: detect a touching of the touch screen display displaying a plurality of textual characters; determine a location of the touching; determine that the touching is a cursor placement touching; identify a location in the textual characters corresponding to the cursor placement touching; shift a first content sub-area including a portion of the textual characters corresponding to the touching away from the location of the touching to create a space between the first content sub-area and a second content sub-area proximate to the location of the touching; and indicate the determined location in the text characters.

Additionally, the instructions may further cause the at least one processor to insert a cursor at the determined location in the textual characters.

### BRIEF DESCRIPTION OF THE DRAWINGS

Reference is made to the attached drawings, wherein elements having the same reference number designation may represent like elements throughout.

FIG. 1 is a diagram of an exemplary device in which methods and systems described herein may be implemented;

FIG. 2 is a functional block diagram of exemplary components implemented in the device of FIG. 1;

FIG. 3 is a block diagram of components implemented in the device of FIG. 2 according to an exemplary implementation;

FIGS. 4A to 6B illustrate screen shots of an exemplary display consistent with embodiments described herein; and

FIG. 7 is a flow diagram illustrating exemplary processing associated with selecting a content item or positioning a cursor.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

### Exemplary System

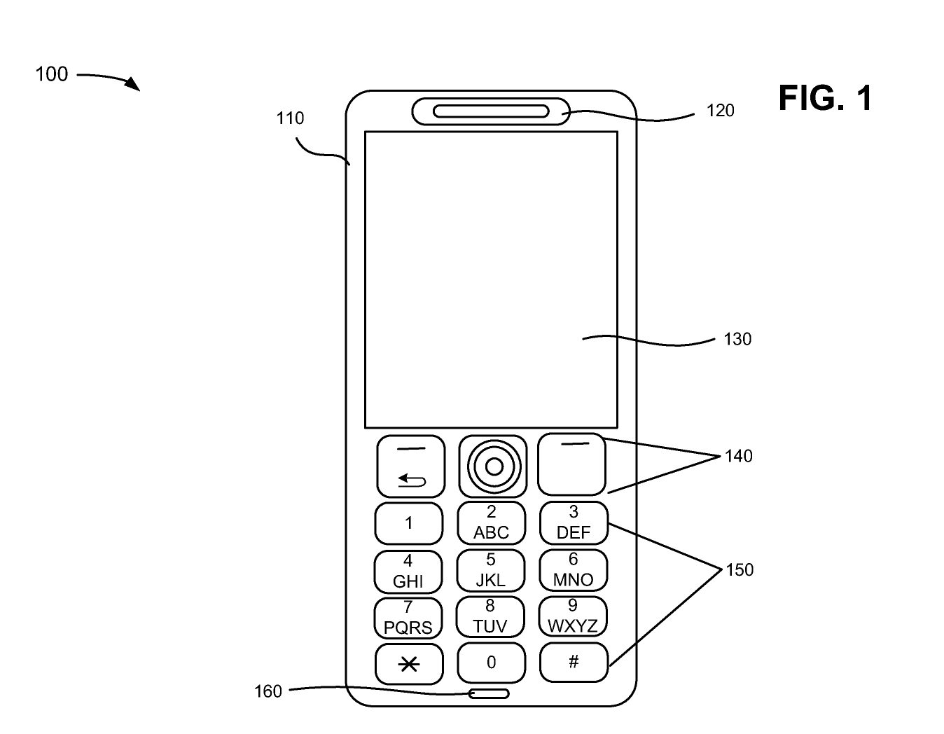

FIG. 1 is a diagram of an exemplary user device 100 in which methods and systems described herein may be implemented. In an exemplary implementation, user device 100 may be a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. It should also be understood that systems and methods described herein may also be implemented in other devices that display information of interest and allow users to interact with the displayed information with or without including various other communication functionality. For example, user device 100 may include a personal computer (PC), a laptop computer, a personal digital assistant (PDA), a media playing device (e.g., an MPEG audio layer 3 (MP3) player, a video game playing device), a global positioning system (GPS) device, etc., that may not include various communication functionality for communicating with other devices.

Referring to FIG. 1, user device 100 may include a housing 110, a speaker 120, a display 130, control buttons 140, a keypad 150, and a microphone 160. Housing 110 may protect the components of user device 100 from outside elements. Speaker 120 may provide audible information to a user of user device 100.

Display 130 may provide visual information to the user. For example, display 130 may provide information regarding incoming or outgoing telephone calls, electronic mail (e-mail), instant messages, short message service (SMS) messages, etc. Display 130 may also display information regarding various applications, such as a messaging or notes application stored in user device 100, a phone book/contact list stored in user device 100, the current time, video games being played by a user, downloaded content (e.g., news or other information), songs being played by the user, etc. Consistent with implementations described herein, display 130 may be a touch screen display device that allows a user to enter commands and/or information via a finger, a stylus, a mouse, a pointing device, or some other device. For example, display 130 may be a resistive touch screen, a capacitive touch screen, an optical touch screen, an infrared touch screen, a surface acoustic wave touch screen, or any other type of touch screen device that registers an input based on a contact with the screen/display 130.

Control buttons 140 may permit the user to interact with user device 100 to cause user device 100 to perform one or more operations, such as place a telephone call, play various media, etc. In an exemplary implementation, control buttons 140 may include one or more buttons that controls various applications associated with display 130.

Keypad 150 may include a standard telephone keypad. Microphone 160 may receive audible information from the user for activating applications or routines stored within user device 100.

Although user device 100 shown in FIG. 1 includes keypad 150 and a number of control buttons 140, it should be understood that user device 100 need not include such features. Rather, in some implementations, user device 100 may include touch screen display 130 alone, or in combination with fewer control buttons 130.

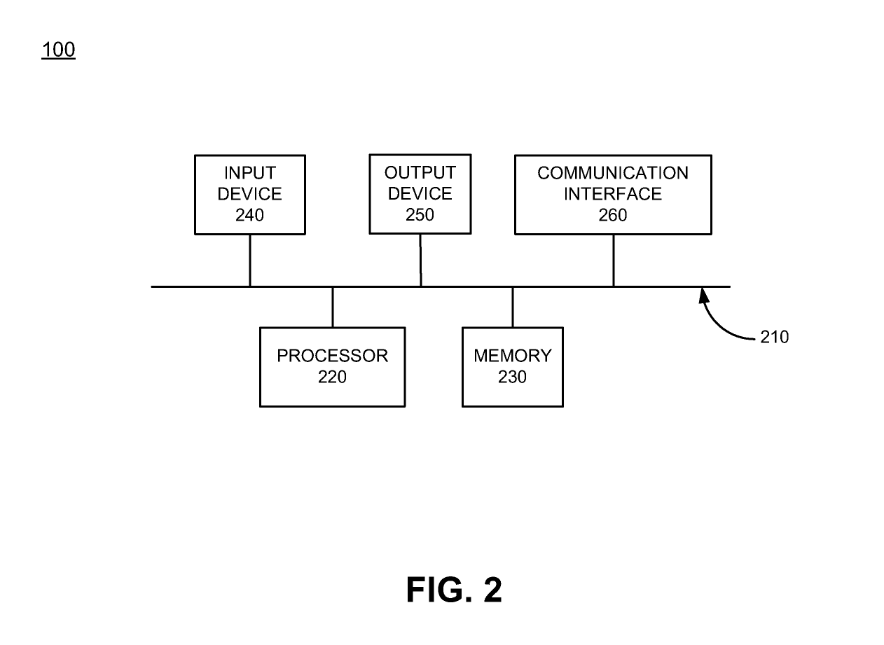

FIG. 2 is a diagram illustrating components of user device 100 according to an exemplary implementation. User device 100 may include bus 210, processor 220, memory 230, input device 240, output device 250 and communication interface 260. Bus 210 permits communication among the components of user device 100. One skilled in the art would recognize that user device 100 may be configured in a number of other ways and may include other or different elements. For example, user device 100 may include one or more modulators, demodulators, encoders, decoders, etc., for processing data.

Processor 220 may include a processor, microprocessor, an application specific integrated circuit (ASIC), field programmable gate array (FPGA) or other processing logic. Processor 220 may execute software instructions/programs or data structures to control operation of user device 100.

Memory 230 may include a random access memory (RAM) or another type of dynamic storage device that stores information and instructions for execution by processor 220; a read only memory (ROM) or another type of static storage device that stores static information and instructions for use by processor 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processor 220. Instructions used by processor 220 may also, or alternatively, be stored in another type of computer-readable medium accessible by processor 220. A computer-readable medium may include one or more memory devices.

Input device 240 may include mechanisms that permit an operator to input information to user device 100, such as microphone 160, keypad 150, control buttons 140, a keyboard (e.g., a QWERTY keyboard, a Dvorak keyboard, etc.), a gesture-based device, an optical character recognition (OCR) based device, a joystick, a touch-based device, a virtual keyboard, a speech-to-text engine, a mouse, a pen, voice recognition and/or biometric mechanisms, etc. In an exemplary implementation, display 130 may be a touch screen display that acts as an input device.

Output device 250 may include one or more mechanisms that output information to the user, including a display, such as display 130, a printer, one or more speakers, such as speaker 120, etc. As described above, in an exemplary implementation, display 130 may be a touch screen display. In such an implementation, display 130 may function as both an input device and an output device.

Communication interface 260 may include any transceiver-like mechanism that enables user device 100 to communicate with other devices and/or systems. For example, communication interface 260 may include a modem or an Ethernet interface to a LAN. Communication interface 260 may also include mechanisms for communicating via a network, such as a wireless network. For example, communication interface 260 may include one or more radio frequency (RF) transmitters, receivers and/or transceivers and one or more antennas for transmitting and receiving RF data via a network.

User device 100 may provide a platform for a user to send and receive communications (e.g., telephone calls, electronic mail messages, text messages, multi-media messages, short message service (SMS) messages, etc.), play music, browse the Internet, or perform various other functions. User device 100, as described in detail below, may also perform processing associated with enabling a user to select an item or location on touch screen display 130 in a manner that increases the accuracy with which the selection is made. User device 100 may perform these operations in response to processor 220 executing sequences of instructions contained in a computer-readable medium, such as memory 230. Such instructions may be read into memory 230 from another computer-readable medium via, for example, and communication interface 260. In alternative embodiments, hard-wired circuitry may be used in place of or in combination with software instructions to implement processes consistent with the invention. Thus, implementations described herein are not limited to any specific combination of hardware circuitry and software.

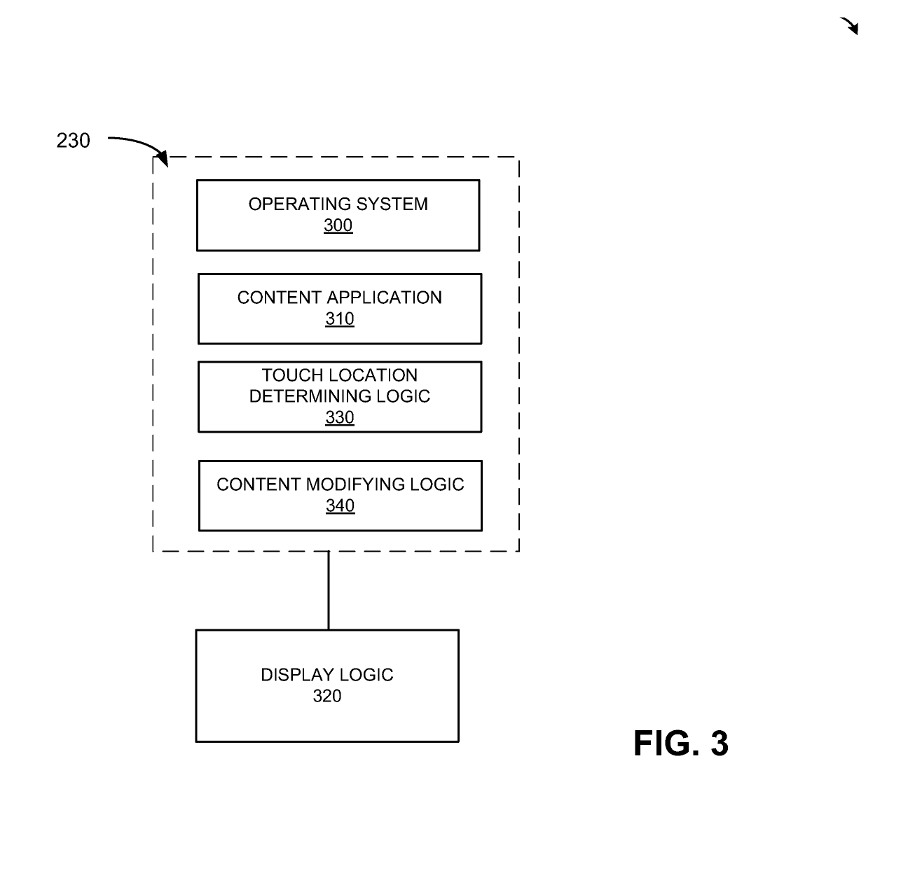

FIG. 3 is an exemplary block diagram of components implemented in user device 100 of FIG. 2. In an exemplary implementation, all or some of the components illustrated in FIG. 3 may be stored in memory 230. For example, referring to FIG. 3, memory 230 may include an operating system (OS) 300, a content application 310, display logic 320, touch location determining logic 330, and content modifying logic 340.

Operating system 300 may include software instructions for managing hardware and software resources of user device 100. Operating system 300 may manage, for example, its file system, device drivers, communication resources (e.g., radio receiver(s), transmission control protocol (TCP)/IP stack), event notifications, etc. Operating system 300 may include Symbian®, Android™, Windows Mobile®, Apple® OS X, etc.

Content application 310 may include any software program or an element of a software program (e.g., a process) executed by processor 220 that displays content items or elements to the user via display 130. Exemplary content applications 210 include Internet browsers, image or video displaying applications, email clients, text messaging clients, instant messaging clients, and productivity applications, such as word processors, spreadsheet editors, etc. As used herein, the term “content application” may refer to any application that outputs or otherwise displays text, images, or video, via display 130.

Display logic 320 may include logic configured to output content from content application 310 via display 130. For example, display logic 320 may be configured to optimize and output content associated with content application 310 based on the specifications (e.g., resolution, etc.) associated with touch screen display 130.

Touch location determining logic 330 may include logic configured to identify one or more locations on touch screen display 130 corresponding to a point (or points) of contact associated with a user's input (e.g., a finger). For example, touch location determining logic 330 may include logic configured to determine the position of a user's finger, a stylus, or other input device.

For example, in one implementation, touch location determining logic 330 may be configured to measure duration of a touch or input contact. In other words, touch location determining logic 330 may be configured to differentiate between erroneous (e.g., unintentional) touches, short touches (e.g., touches having a duration of less than 1 to 1.5 seconds), and long touches (e.g., touches having a duration of more than 1 to 1.5 seconds). Further, touch location determining logic 330 may be configured to identify whether a touch is stationary (e.g., a single press), or whether a touch is moving (e.g., a press and slide, or flick), and in what direction and at what relative speed the touch is moving. This information may be used by various applications within user device 100 to interface with user device 100.

Consistent with implementations described herein, content application 310 may, in combination with touch location determining logic 330, be configured to determine that a user wishes to place a cursor within a particular portion of the content displayed via display 130. Alternatively, content application 310 may be configured to determine that a user wishes to select a particular portion of the content displayed via display 130. For example, a long touch identified by touch location determining logic may cause content application 310 (e.g., an email client) to determine that the user wishes to place a cursor at a specific location within the displayed content (e.g., an email message). In some implementations, subsequent movement of the touch (e.g., dragging or sliding while maintaining contact with touch screen 130) may cause the content application 310 to select additional content in a direction corresponding to the movement of the touch.

Content modifying logic 340 may include logic configured to modify the output of content on display 130 upon recognition that the user wishes to place a cursor within a particular portion of the content or that the user wishes to select a particular item or portion of the content. In one implementation, content modifying logic 340 may shift content adjacent to the selected portion in a manner that creates an empty or “white” space in proximity to the selected location or content. In some implementations, the empty space may be provided in an area of display 130 underlying or adjacent to the digit/stylus used to contact display 130.

By providing an empty space proximate to the selected portion of the content, the selected portion or location may be differentiated from non-selected portions of the content without having to enlarge or otherwise distort the selected portion, thereby making the selected portion or location easier to identify. Furthermore, providing an empty space underlying or adjacent to the digit/stylus used to contact display 130 enables the user to contact display 130 without overly obscuring the content being selected.

The programs and logic blocks illustrated in FIG. 3 are provided for simplicity. It should be understood that other configurations may be possible. It should also be understood that functions described as being performed by one program or logic block within a program may alternatively be performed by another program and/or another logic block. In addition, functions described as being performed by multiple programs or logic blocks may alternatively be performed by a single program or logic block/device.

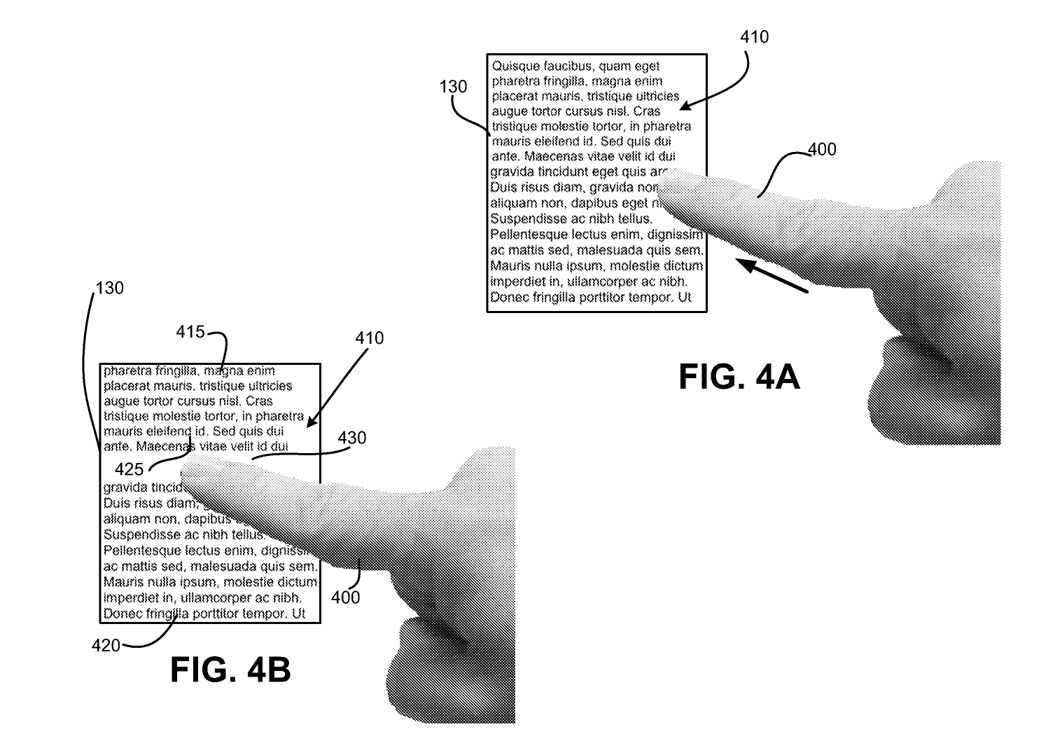

FIGS. 4A to 6B are screen shots of exemplary display 130 consistent with embodiments described herein. More particularly, FIG. 4A illustrates display 130 prior to user interaction (e.g., via finger 400) with touch screen display 130 to, e.g., select a location for a cursor location. As shown, display 130 may include a content area 410 displaying text content therein.

FIG. 4B discloses display 130 following user interaction (e.g., via finger 400). For example, as described briefly above, touch location determination logic 330 may determine that finger 400 has contacted a location within content area 410 for a predetermined period of time (e.g., a long touch). In this example, the user has selected a portion of content area 410 corresponding to a location between the letters “a” and “s” in the work “Maecenas.”

When it is determined that the user has touched a particular portion of display 130 for the predetermined period of time (e.g., more than 1 second), content modifying logic 340 may modify the output of display 130 to enable the user to more accurately determine the location of the interaction. For example, as shown in FIG. 4B, content elements within content area 410 may be divided into two content sub-areas 415 and 420, with content sub-area 415 being raised or offset relative to content sub-area 420 in proximity to the selected content. Alternatively, content sub-area 420 may be lowered relative to content sub-area 415 to obtain a similar effect. In some implementations (e.g., text-based selections), a cursor 425 may be inserted into the location of content area 410 corresponding to the user's initial point of contact. In other implementations, other forms of selection indicia (e.g., highlighting, coloring, etc.) may be used to indicate the selected status of a content item.

By separating content sub-areas 415 and 420 relative to one another, various benefits may be obtained. First, the blank or empty space 430 formed by the separation between sub-area 415 and sub-area 420 may enable the user to more easily discern or identify the portion of the content currently being selected (e.g., the text corresponding to the term “Maecenas” in FIG. 4B). Secondly, the blank space may be positioned under the user's finger or stylus (or other input element), thereby better allowing the user to clearly view and/or read the portion of the content being selected, as well as the content elements adjacent to the selected portion, without requiring distortion (e.g., magnification, etc.) of the selected content relative to adjacent content.

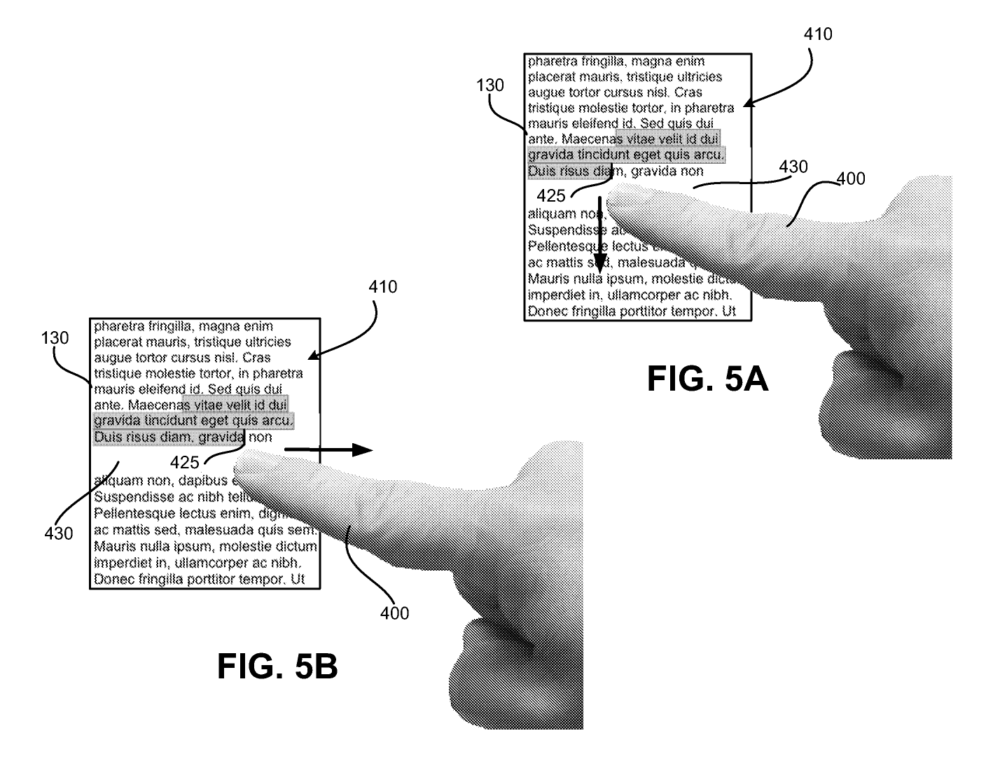

Upon modification of the displayed content by content modifying logic 340, additional operations may be performed on the selected content. For example, as illustrated in FIG. 5A, the user may interact with the selected content by dragging or sliding finger 400 up or down (e.g., vertically) within content area 410, as illustrated by the downward arrow. In one implementation (as depicted in FIG. 5A), such vertical movement may cause additional rows of content to be selected or deselected. As each row is selected or deselected, space 430 may be shifted within content area 410 to allow easy identification of the selected portion furthest from the initial selection point.

In another implementation (not shown), vertical movement may cause movement of the cursor or selected item corresponding to movement of finger 400. For example, as the user drags finger 400 down, cursor 425 may move down in a corresponding manner. In this implementation, as each row is traversed, space 430 may be shifted to allow easy identification a portion of content area 410 corresponding to the presently selected portion. In this manner, the portion of the content being selected may be easily viewed, while the selection is being made.

Similar to FIG. 5A, FIG. 5B illustrates one implementation of left and right (e.g., horizontal) interaction with display 130 upon modification by content modifying logic 340. Horizontal movement may cause additional characters or content elements in a row to be selected or deselected. In another implementation (not shown), horizontal movement may cause movement of the cursor or selected item corresponding to movement of finger 400. For example, as the user drags finger 400 to the right, cursor 425 may move to the right in a corresponding manner.

Although shown independently in FIGS. 5A and 5B, it should be understood that horizontal and vertical movement may be performed simultaneously with the combined effects being observed. For example, movement down and to the right may cause cursor 425 to move down and to the right from the originally selection portion. Simultaneously, blank space 430 may shift down a corresponding amount to ensure that black space 430 is immediately below the lowest (or current) selected portion.

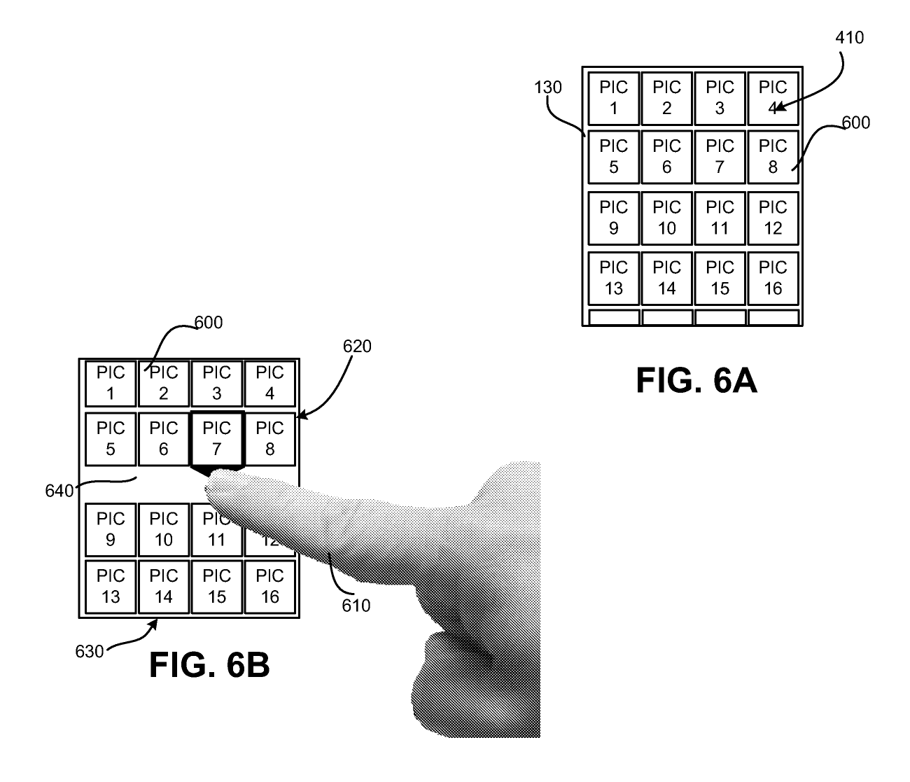

FIGS. 6A and 6B illustrate screen shots of exemplary display 130 consistent with non-textual implementations. As illustrated in FIG. 6A, content area 410 in display 130 may include an image browser or image library 600 having a number of images, labeled PIC1 to PIC16, therein. As shown, in one implementation, display 130 may display thumbnail (e.g., smaller) images for each image in library 600.

FIG. 6B discloses display 130 following user interaction (e.g., via finger 610). For example, as described briefly above, touch location determination logic 320 may determine that finger 610 has contacted a particular image within image library 600 for a predetermined period of time (e.g., a long touch). In this example, the user has selected a “PIC 7” in image library 600.

When it is determined that the user has touched a particular portion of display 130 for the predetermined period of time (e.g., more than 1 second), content modifying logic 340 may modify the output of display 130 to enable the user to more accurately determine the location of the interaction. For example, as shown in FIG. 6B, thumbnail images within image library 600 may be divided into two content sub-areas 620 and 630, with content sub-area 620 being raised or offset relative to content sub-area 630 in proximity to the selected thumbnail. As illustrated, the selected image thumbnail may be indicated by a selection indicia, such as highlighting, coloring, etc.

By separating content sub-areas 620 and 630 relative to one another, various benefits may be obtained. First, the blank or empty space 640 formed by the separation between sub-area 620 and sub-area 630 may enable the user to more easily discern or identify the selected content element (e.g., “Pic 7”). Secondly, blank space 640 may be positioned under the user's finger or stylus (or other input element), thereby better allowing the user to clearly view the selected content item. This allows display 130 to present thumbnail images or other content items having smaller dimensions, since the images or other items are not unnecessarily obscured during selection.

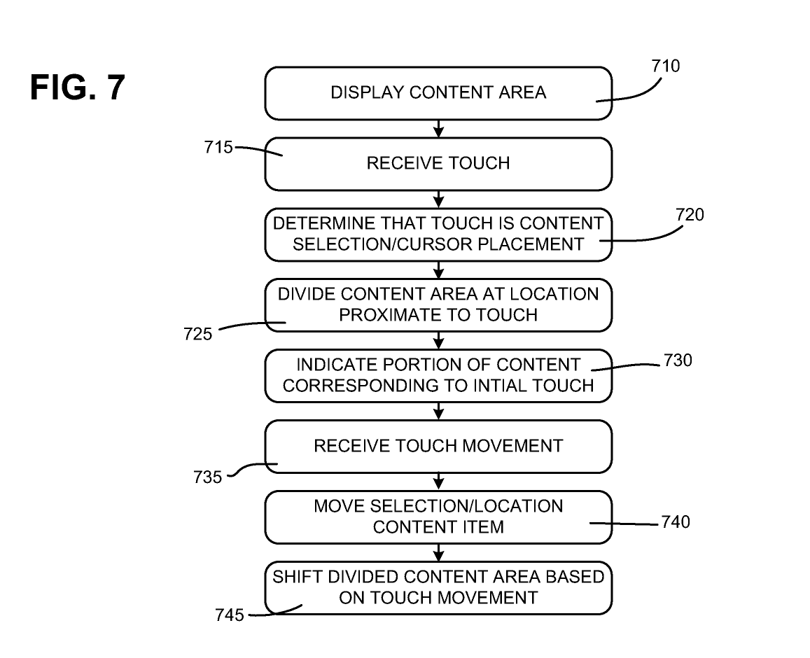

FIG. 7 illustrates exemplary processing for selecting content items or cursor locations on a touch screen device. Processing may begin with user device 100 displaying a content area having a number of content items provided thereon (act 710). For example, content application 310 may output content items, such as text characters, images (e.g., thumbnail images), files, etc. via display logic 320.

Device 100 may receive a user interaction (e.g., a touch) (block 715). For example, touch location determining logic 330 may determine that a user has performed a touch of touch screen 130, the duration of the touch, and the location of the touch.

Device 100 may determine that the touch is a content item selection touch or cursor placement touch (block 720). For example, content application 310 may determine that a location corresponding to the identified touch includes selectable content and/or text. Additionally, content application 310 may determine that a duration of the touch is greater than a predetermined duration (e.g., 1 second).

Display modifying logic 340 may divide the content area in a position proximate to the detected touch (block 725). In one implementation, dividing the content area creates a first content sub-area and a second sub-area separated by a blank space or gap, such as gap 430 or gap 640. Furthermore, the first content sub-area may include the content item/cursor location that initially corresponded to the detected touch. The first sub-area may be shifted away or offset from the physical touch location, such that the physical touch location (e.g., the position of the user's finger or stylus on display 130) remains in the blank space or gap formed between the first content sub-area and the second content sub-area. In one implementation, the first content sub-area is shifted up relative to the second content sub-area.

Consistent with implementations described herein, the width of gap 430/640 may be dynamically adjusted based on the size or contact area associated with the identified touch. For example, detection of a user having a large finger (e.g., by touch location determining logic 330) may result in a wider gap 430/640, whereas detection of a user with a smaller finger or using a stylus, may result in a narrower gap 430/640. In some instances, the width of gap 430/640 may be sized to reduce the amount of content obscured by the contacting digit or implement, while simultaneously maximizing the amount of content displayed on display 130.

The portion of the content corresponding to the initially selected location may be indicated (block 730). For example, a cursor may be positioned at the selected location for text-based content. Alternatively, for non-text content (e.g., images, etc.), the selected image or content element may be highlighted or otherwise visually indicated.

A touch movement may be received (block 735). For example, touch location determining logic 330 may determine that the detected touch has moved relative to its initial location. In response, the selected location/content item may be moved in a corresponding manner (block 740). Content modifying logic 340 may shift the divided content area based on the movement of the detected touch (block 745). For example, movement of the touch in a downward or upward manner may cause the content area divide (e.g., the space between the first content sub-area and the second content sub-area, such as space 430 or 640) to move in a corresponding manner, such that a currently selected portion remains immediately above the blank space.

In some implementations, movement of the touch may cause content application 310 to select a portion of the content located between the initially selected portion and the portion corresponding to the end of the touch movement. In other implementations, movement of the touch may cause content application 310 to move the selection from the portion of the content that was initially selected to the portion of the content corresponding to the end of the touch movement.

### CONCLUSION

Implementations described herein provide a method and device for enabling accurate selection of content items or cursor positioning on a touch screen device. In one implementation, upon detecting a touching, a portion of the displayed content corresponding to the touch may be shifted away from the physical location of the touch and also from a remaining portion of the content. This effectively inserts a blank space or gap between the selected content portion and the remaining content. The positioning of the gap enables the user to easily identify the selected portion of the content or the position of the cursor and further allows for unencumbered viewing of the selected content/cursor location and its adjacent content. This may further enhance the user's overall experience with respect to use of the user device.

The foregoing description of the embodiments described herein provides illustration and description, but is not intended to be exhaustive or to limit the invention to the precise form disclosed. Modifications and variations are possible in light of the above teachings or may be acquired from the practice of the invention.

Further, while series of acts have been described with respect to FIG. 7, the order of the acts may be varied in other implementations consistent with the invention. Moreover, non-dependent acts may be performed in parallel.

It will also be apparent to one of ordinary skill in the art that aspects of the invention, as described above, may be implemented in computer devices, cellular communication devices/systems, media playing devices, methods, and/or computer program products. Accordingly, aspects of the present invention may be embodied in hardware and/or in software (including firmware, resident software, micro-code, etc.). Furthermore, aspects of the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code--it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an ASIC, an FPGA or other processing logic, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

The scope of the invention is defined by the claims and their equivalents.

What is claimed is:

1. A method for interacting with a touch screen display, comprising:
displaying content items in a content area on the touch screen display;
detecting a touching of the touch screen display;
determining a location of the touching;
dividing the content area into a first content sub-area and a second content sub-area at a location proximate to the location of the touching such that a portion of the content items are in the first content sub-area and a portion of the content items are in the second content sub-area,
wherein a portion of the content items corresponding to the touching is included in the first content sub-area; and
shifting the first content sub-area away from the location of the touching to create a space between the first content sub-area and the second content sub-area.

2. The method of claim 1, wherein the content items comprise textual elements or graphical elements.

3. The method of claim 1, wherein the first content sub-area is shifted upward on the touch screen display relative to the location of the touching.

4. The method of claim 1, wherein detecting the touching further comprises determining whether the touching is a content item selection or cursor placement touching.

5. The method of claim 1, further comprising:
determining a duration of the touching;
determining a movement of the touching; and
determining that the touching is a content item selection or cursor placement touching based on at least of the duration of the touching or the movement of the touching.

6. The method of claim 5, wherein it is determined that the touching is a content item selection or cursor placement touching when the duration of the touching is at least one second and the touching is stationary.

7. The method of claim 1, further comprising:
determining that the touching is moving vertically with respect to the content items; and
shifting the first content sub-area and the second content sub-area such that the space between the first content sub-area and the second content sub-area remains proximate to the location of the touching.

8. The method of claim 7, wherein the vertical movement causes selection of the content items between a starting location of the touching and an ending location of the touching.

9. The method of claim 7, wherein the vertical movement causes movement of a cursor or selected content item from the portion corresponding to a starting location of the touching to the portion corresponding to an ending location of the touching.

10. The method of claim 1, further comprising:
indicating the portion of the content items corresponding to the touching in the first content sub-area.

11. The method of claim 1, further comprising:
determining a contact size associated with the touching; and
dividing the first content sub-area from the second content sub-area by an amount based on the contact size.

12. A mobile terminal, comprising:
a touch screen display for displaying content in a content area of the touch screen display; and
a processor to:
detect a touching of the touch screen display;
determine a location of the touching;
divide the content area into a first content sub-area and a second content sub-area at a location proximate to the location of the touching, with a portion of the content being in the first content sub-area and a portion of the content being in the second content sub-area,
wherein a portion of the content corresponding to the touching is included in the first content sub-area;
shift the first content sub-area away from the location of the touching to create a space between the first content sub-area and the second content sub-area; and
indicate the portion of the content corresponding to the touching in the first content sub-area.

13. The mobile terminal of claim 12, wherein the space between the first content sub-area and the second content sub-area is proximate to the portion of the content corresponding to the touching.

14. The mobile terminal of claim 12, wherein the content comprises textual elements or graphical elements.

15. The mobile terminal of claim 12, wherein the first content sub-area is shifted upward relative to the location of the touching.

16. The mobile terminal of claim 15, wherein the processor is further configured to:
determine a duration of the touching;
determine a movement of the touching; and
determine that the touching is a content item selection or cursor placement touching based on at least of the duration of the touching or the movement of the touching.

17. The mobile terminal of claim 12, wherein the processor is further configured to highlight the portion of the content corresponding to the touching in the first content sub-area.

18. The mobile terminal of claim 12, wherein the processor is further configured to:
determine a contact size associated with the touching; and
divide the first content sub-area from the second content sub-area by an amount based on the contact size.

19. A computer-readable medium having stored thereon a plurality of sequences of instructions which, when executed by at least one processor, cause the at least one processor to:
detect a touching of the touch screen display displaying a plurality of textual characters;
determine a location of the touching;
determine that the touching is a cursor placement touching;
identify a location in the textual characters corresponding to the cursor placement touching;
shift a first content sub-area including a portion of the textual characters corresponding to the touching away from the location of the touching to create a space between the first content sub-area and a second content sub-area proximate to the location of the touching; and
indicate the determined location in the text characters.

20. The computer-readable medium of claim 19, wherein the instructions further cause the at least one processor to insert a cursor at the determined location in the textual characters.
